(19) United States
(12) Patent Application Publication
(10) Pub. No.: US 2021/0274821 A1
(43) Pub. Date: Sep. 9, 2021

(54) HEALTHY SNACK FOOD OR SUPPLEMENT

(71) Applicant: Zhi Qiang Guo, Edmonton (CA)

(72) Inventor: Zhi Qiang Guo, Edmonton (CA)

(21) Appl. No.: 16/811,097

(22) Filed: Mar. 6, 2020

(51) Int. Cl. A23L 25/00; A23L 27/00; B65B 31/02; B65D 75/12

(52) U.S. Cl. CPC A23L 25/30; B65D 75/12; B65B 31/021; A23L 27/88

(57) ABSTRACT

The present invention relates to mixed nuts and seeds that be used as a healthy snack food or dietary supplement. The mixed nuts and seeds can be ground, pulverized or milled to different textures from course to medium to fine. The resulting flour has a good taste and can be mixed with other flours or various flavorings. It can be mixed with various different liquids or binders. It can be added to raw foods or can be added to foods prior to cooking.

### FIELD OF THE INVENTION

The present disclosure relates to healthy snack foods, particularly to long life healthy snack foods and more particularly to long life healthy snack foods, flours or supplements.

### BACKGROUND

It is common for instant foods and snacks to be convenient and tasty but often unhealthy, like chocolate candy bars, potato chips, pretzels, peanut butter crackers and cookies. Although traditional snacks are appealing in taste and convenience, they have a negative impact on the health of consumers. In particular, it is generally acknowledged that high fat, high salt, high calorie, and low dietary fiber levels in traditional snack foods contribute to obesity and to many chronic diseases, such as diabetes, high blood pressure, heart disease, stroke, and certain types of cancer.

Instant or snack foods are typically products which are designed to be eaten not as a main or substantial meal, but as snacks or supplements to a person's diet or as a supplement to other food products. Various different types of sweet and savory instant or snack foods are known in the market, however, existing snack foods, and some food supplements tend to have the disadvantage of a high sugar or fat content. For this reason, such foods cannot be regarded as a healthy option due to the high calorie or lipid content.

US20160213045 discloses a confection food product and method for making a confection food product comprising a binder, typically a sugar or oil solution, and a dried component such nuts, dried fruit or cereal. The process of manufacture, includes combining these ingredients, which are thoroughly mixed with heat and then formed and transferred into a drying oven. The invention relates the use of binders that are a more healthy, flavorful alternative to conventional and existing binders.

CA2422028 discloses a crispy savory snack food comprising dried ingredients such as cereals, seeds and nuts which is agglomerated by a binder comprising polysaccharides or oil. The dried ingredients may include: legumes, for example soy beans and lentils; one or more seeds, such as sesame, sunflower, pumpkin and flax; one or more nuts, which may be ribbed, crushed or flaked; suitable nuts include almonds, hazelnuts, brazil nuts, peanuts, pistachio nuts, cashews, walnuts, pine nuts and pecans. The polysaccharide may contain certain flavorings and/or small amounts of fat.

CN107319283 discloses a total-nutrient meal replacement powder containing fruit enzyme powder. The total-nutrient meal replacement powder is prepared from the following raw materials: the fruit enzyme powder, cereals, plant kernels, plant seeds, fructus schisandrae, flos chrysanthemi, flos sophorae, flos lablab album, rosa rugosa var plena, hericium erinaceus, nori, pine pollen, black fungi, fructus jujubae, semen ziziphi spinosae, fructus crataegi, semen cassiae, folium nelumbinis, fructus lycii, fructus hippophae, dried longan pulp, radix astragali seu hedysari, rhizoma polygonati, fructus cormi, fructus perillae, fig, radix polygoni multiflori and mulberry fruit. The fruit enzyme powder is applied to the field of meal replacement powder and can be matched with other raw materials in a meal replacement powder formula, so that a complementary function is realized.

U.S. Pat. No. 3,876,811 discloses a cereal comprising a base and a coating thereon. The base comprises cereal flakes, coconut, milk solids, and edible nuts. The coating comprises brown sugar, non-hydrogenated vegetable oil, and a sugar solution.

U.S. Pat. No. 5,424,085 discloses a method for producing translucent amorphous sugar-coated edible nuts and seeds. Individual coated nuts or seeds are produced by mixing nuts or seeds with coating syrup (including sugar and sweetener syrup), then cooling until the coating syrup begins to set, then adding separating composition, and when individual coated nuts are produced, optionally coating with particulate ingredients and/or a protective emulsifier coating, then optionally coating with chocolate.

US20140287132 discloses a process for assembling and creating a nutritious snack mix composition having a desired combination of flavors, seasoning, and portions, and having a low moisture content. The snack mix composition comprises at least one meat jerky, at least one dried fruit, and at least one nut product. The process comprises selecting the desired ingredients and packing them in a commercial product pouch and inserting a moisture-absorbing sachet into each pouch. Excess air is removed from each pouch prior to sealing.

U.S. Pat. No. 5,612,074 discloses a nutrient fortified non-cooked food bar containing dry and wet ingredients. Dry ingredients include dietary fibers, non-animal proteins, oil seeds, amino acids, and ingredients containing chlorophyll, pyridoxine, magnesium. The mixture of liquid ingredients includes syrup sweeteners, vegetable oils, and liquid flavorings.

U.S. Pat. No. 3,317,325 discloses a free-flowing nut product and a process for making it. Nut butters may be made from peanuts, almonds, pecans, walnuts, hazel nuts, cashews, sesame seeds, and the like. The process is particularly adaptable to the addition of flavorings such as honey, imitation nut flavors, fruit flavors, and the like. They may be added with the water and encapsulated along with fat.

U.S. Pat. No. 6,139,884 discloses a high energy food product which consists primarily of an admixture of barley, flax and teff, and a binder which holds the admixture together. The binder includes corn syrup, honey, canola oil, ground sunflower seeds, and it is added to the admixture after the barley, flax and teff have been mixed together.

WO2005096837 discloses a ready-to-use therapeutic food or nutritional supplement that comprises a mixture of at least one ground, roasted cereal, and at least one ground, roasted legume or cooked leguminous protein extract. Also disclosed is a method of making a ready-to-use food or nutritional supplement, which comprises mixing at least one ground, roasted cereal with at least one ground, roasted legume or leguminous protein extract. The food or nutritional supplement may also include an energy supplement such as fat, oil or sugar to increase the energy concentration of the mix.

All above cited documents are incorporated herein by reference.

None of the above cited documents however, alone or in combination, satisfy the need for a food product that is a healthy snack food, flour or dietary supplement. Hence there remains a need for a healthy snack food, flour or dietary supplement that: is free from binders that are high in sugars and fats; has balanced nutrients and is good for you; has a long shelf life; made from nuts and seeds; and can be eaten as provided; can be suspended in liquids or added as a supplement to other food stuffs or generally to a person's diet.

### BRIEF SUMMARY

It is an object of the invention to provide a healthy snack food or supplement.

In accordance with an aspect of the invention there is provided a food product, comprising in admixture ingredients selected from: black sesame seeds; white sesame seeds; sunflower seeds; almonds; cashews; hemp seeds; green algae; wheat grass; yeast; green tea; ginger; sugar; wheat bran powder; walnuts; brazil nuts; pecan nuts; peanuts; chia; poppy seeds; flex seeds; and pumpkin seeds.

In accordance with another aspect of the invention there is provided a method of preparing a snack food or supplement, comprising the steps of: choosing desired dry ingredients selected from: black sesame seeds; white sesame seeds; sunflower seeds; almonds; cashews hemp seeds; green algae; wheat grass; yeast; green tea; ginger; sugar; wheat bran powder; walnuts; brazil nuts; pecan nuts; chia; poppy seeds; flex seeds; and pumpkin seeds; combining the dry ingredients; milling, grounding, or pulverizing the dry ingredients to the appropriate particulate size; packaging the milled, ground or pulverized dry ingredients individual snack packages or pouches; optionally inserting one or more moisture or oxygen absorbing sachets into the individual snack packages or pouches; removing excess air from the individual snack packages or pouches; sealing the individual snack packages or pouches.

In accordance with an embodiment of the invention there is provided a food product, as described above, that has been ground, milled or pulverized into particulate matter in region of between 30 to 10 US mesh (560 to 2000 microns), preferably 24 to 14 US mesh (690 to 1400 microns) and more preferably 20 to 18 US mesh (850 to 1000 microns).

In accordance with a further embodiment of the invention there is provided a food product, as described above, additionally comprising one or more flavorings or powdered components are added to the selected ingredients, said flavorings being selected from: salt; pepper (including black pepper); vanilla; caramel; peppermint; citrus or coconut flavoring; cocoa powder; cinnamon; nutmeg; ginger; chili; cumin; coriander; curry; barbecue flavoring; paprika; and garlic, and said powdered components being selected from: Chinese date flour; American ginseng flour; Korean ginseng flour; Astragalus membranaceus flour; panax notoginseng (sangti) flour; root of pilose asiabell flour; roasted chinese yam flour; black beans flour; cauliflower flour; mushroom flour; tomato flour; grape seeds flour; lecithin flour; protein; digestive enzymes; ganoderma flour; and powdered milk.

The advantages and features of the present invention will become better understood with reference to the following more detailed description and claims taken in conjunction with the accompanying Tables.

### DETAILED DESCRIPTION

Formulae and methods for producing the invention are presented in terms of embodiments depicted within the Tables and the Description. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope of the invention.

The present invention relates to mixed nuts and seeds that are ground into a flour. The flour can be ground, pulverized or milled to different textures from course to medium to fine. The resulting instant food is healthy and has a good taste and can be consumed as a ready-to-eat cereal product completely free of chemical additives and comprised solely of natural ingredients. In the alternative it can be added to raw foods or can be added to foods prior to cooking. The flour can be mixed with wet ingredients or binders to form a paste. The flour can be mixed with various flavorings or other flours. The flour or flours can be used to bake cakes, pies, puddings and pastries.

The flour contains numerous minerals and vitamins in quantities that provide in the region of 90-100% of the recommended daily intake values of these nutrients. The flour can therefore be regarded as a full function plant based multi-mineral and multi-vitamin supplement, which is additionally rich in starch, oil, and protein. Moreover, the absorption rate and in-vivo functions of the multi-mineral and multi-vitamin supplement will be better than most of the supplement products in the market.

The flour is versatile and is easily digested, it can be used as a snack or as a food supplement. The taste is good, the nutrients are balanced and the food product is particularly suitable for adults, especially middle aged, and old people. It will be good for children and youth, however the amount should be scaled down in accordance with recommendations found in the www.whfoods.org web site—typically thirty percent to sixty percent daily intake shown in Tables 1, 2, and 3.

Specifically, embodiments of the invention relate to products made from ingredients comprising, but not limited to: black sesame seeds; white sesame seeds; sunflower seeds; almonds; cashews hemp seeds; green algae; wheat grass; yeast; green tea; ginger; sugar; wheat bran powder; and oil. Additionally, walnuts, brazil nuts, pecan nuts, peanuts, chia, poppy seeds, flex seeds, pumpkin seeds can also be added to the ingredients.

More specifically, formulations of three embodiments of the invention are outlined in Tables 1, 2 and 3. Each table lists weights of ingredients and approximate percentage daily intake of nutrients derived from each ingredient. The daily intake values are calculated from food charts posted on the web site of www.whfoods.org and are expressed in terms of percentage daily value for healthy women aged 25-50.

TABLE 1
relates to Formula 1.

| | Sesame | Sunflower | Almonds | Cashews | Total |
|---|---|---|---|---|---|
| (grams) | 15 | 40 | 5.6 | 10 | 70.6 |
| Copper | 68.0% | | 6.5% | 25.0% | 99.5% |
| Manganese | 18.3% | 36.8% | 6.7% | 8.0% | 69.8% |
| Calcium | 15.0% | 3.2% | | | 18.2% |
| Phosphorus | 13.3% | 36.8% | 4.0% | 8.5% | 62.6% |
| Magnesium | 13.3% | 36.8% | 3.8% | 7.0% | 60.9% |
| Iron | 11.6% | 16.0% | | | 27.6% |
| Zinc | 10.0% | 20.8% | | 5.3% | 36.1% |
| Molybdenum | 10.0% | | 3.8% | | 13.8% |
| Selenium | 10.0% | 39.0% | | | 49.0% |
| Fibre | 6.7% | | 2.8% | | 9.5% |
| Potassium | | | | | 0.0% |
| Sodium | | | | | 0.0% |
| Vitamin B1 | 10.0% | 51.2% | | | 61.2% |
| Vitamin B2 | | 12.0% | 4.5% | | 16.5% |
| Vitamin B3 | | 22.4% | | | 22.4% |
| Vitamin B5 | | 9.6% | | | 9.6% |
| Vitamin B6 | | 40.0% | | | 40.0% |
| Folate | | 22.4% | | | 22.4% |
| Vitamin B12 | | | | | 0.0% |
| Biotin | | | 12.2% | | 12.2% |
| Vitamin A | | | | | 0.0% |
| Vitamin C | | 0.8% | | | 0.8% |
| Vitamin K | | | | | 0.0% |
| Choline | | 4.8% | | | 4.8% |
| Vitamin E | | 92.8% | 10.0% | | 102.8% |
| Protein (g) | 3.7 | 8.3 | 1.2 | 1.6 | 14.8 |
| Lipid (g) | 9.0 | 19.2 | 2.8 | 4.3 | 35.3 |
| Carbohydrate (g) | | 8.0 | | | 8.0 |
| Omega-3 (g) | | | | | |
| Omega-6 (g) | | | | | |

70.6 g of Formula 1 contains: 15.0 g sesame; 40.0 g sunflower; 5.6 g almonds; and 10.0 g cashew. The percentage of daily recommended intake of the various nutrients, vitamins and minerals contributed by the specific ingredients are expressed in the body of the table. This formulation may be mixed with oil, typically in the ratio of 70.6 g of Formula 1 to 19 g oil. By reference to Table 1 it can be seen that a serving of Formula 1 contains 35.3 g unprocessed natural oil & fat (lipids). This will become 54.3 g if mixed with 19 g unprocessed vegetarian oil, thereby increasing the daily value of oil & fat (lipids) to 80.0% of the recommended daily intake.

TABLE 2
relates to Formula 2.

| | | | | | Hemp | Green | Wheat | | |
|---|---|---|---|---|---|---|---|---|---|
| | Sesame | Sunflower | Almonds | Cashews | Seed | Algae | Grass | Yeast | Total |
| (grams) | 15 | 40 | 5.6 | 10 | 9 | 0.5 | 8 | 0.5 | 88.6 |
| Copper | 68.0% | | 6.5% | 25.0% | | | | | 99.5% |
| Manganese | 18.3% | 36.8% | 6.7% | 8.0% | 30.0% | | | | 99.8% |
| Calcium | 15.0% | 3.2% | | | 0.6% | | 4.0% | | 22.8% |
| Phosphorus | 13.3% | 36.8% | 4.0% | 8.5% | 12.0% | | | | 74.6% |
| Magnesium | 13.3% | 36.8% | 3.8% | 7.0% | 24.0% | | | | 84.9% |
| Iron | 11.6% | 16.0% | | | 7.5% | 6.7% | 10.0% | | 51.8% |
| Zinc | 10.0% | 20.8% | | 5.3% | 9.0% | | | | 45.1% |
| Molybdenum | 10.0% | | 3.8% | | | | | | 13.8% |
| Selenium | 10.0% | 39.0% | | | | | | | 49.0% |
| Fibre | 6.7% | | 2.8% | | 1.2% | | 8.0% | 0.4% | 19.1% |
| Potassium | | | | | | | 7.0% | | 7.0% |
| Sodium | | | | | | | | | 0.0% |
| Vitamin B1 | 10.0% | 51.2% | | | 7.5% | | | 30.3% | 99.0% |
| Vitamin B2 | | 12.0% | 4.5% | | 1.2% | | | 20.0% | 37.7% |
| Vitamin B3 | | 22.4% | | | | | | 6.7% | 29.1% |
| Vitamin B5 | | 9.6% | | | | | | | 9.6% |
| Vitamin B6 | | 40.0% | | | 3.0% | | | 11.0% | 54.0% |
| Folate | | 22.4% | | | 6.0% | | | 16.3% | 44.7% |
| Vitamin B12 | | | | | | 62.5% | | 29.3% | 91.8% |
| Biotin | | | 12.2% | | | | | | 12.2% |
| Vitamin A | | | | | | 10.0% | | | 10.0% |
| Vitamin C | | 8.0% | | | | | 6.0% | | 14.0% |
| Vitamin K | | | | | | | 100.0% | | 100.0% |
| Choline | | 4.8% | | | | | | | 4.8% |
| Vitamin E | | 92.8% | 10.0% | | | | | | 102.8% |
| Protein (g) | 3.7 | 8.3 | 1.2 | 1.6 | 3 | | | 0.3 | 18.1 |
| Lipid (g) | 9.0 | 19.2 | 2.8 | 4.3 | 4.5 | | | | 39.8 |
| Carbohydrate (g) | | 8 | | | | | | | 8.0 |
| Omega-3 (g) | | | | | 0.8 | | | | 0.8 |
| Omega-6 (g) | | | | | 2.7 | | | | 2.7 |

88.1 g of Formula 2 contains: 15.0 g sesame; 40.0 g sunflower; 5.6 g almonds; 10.0 g cashews; 9.0 g hemp seeds; 0.5 g powdered green algae; 8.0 g wheat grass; and 0.5 g yeast. Again, the percentage of daily recommended intake of the various nutrients, vitamins and minerals contributed by the specific ingredients are expressed in the body of the table. This formulation may be mixed with oil, typically in the ratio of 88.1 g of Formula 2 to 23.0 g oil. By reference to Table 2 it can be seen that a serving of Formula 2 contains 39.8 g unprocessed natural oil & fat (lipids). This will become 62.8 g if mixed with 23 g unprocessed vegetarian oil, thereby increasing the daily value of oil & fat (lipids) to 94.2% of the recommended daily intake.

TABLE 3
relates to Formula 3.

| | | | | | Hemp | Green | Wheat | | Wheat bran | |
|---|---|---|---|---|---|---|---|---|---|---|
| | Sesame | Sunflower | Almonds | Cashews | Seed | Algae | Grass | Yeast | powder | Total |
| (grams) | 15 | 40 | 5.6 | 10 | 9 | 0.5 | 8 | 0.5 | 100 | 188.6 |
| Copper | 68.0% | | 6.5% | 25.0% | | | | | | 99.5% |
| Manganese | 18.3% | 36.8% | 6.7% | 8.0% | 30.0% | | | | | 99.8% |
| Calcium | 15.0% | 3.2% | | | 0.6% | | 4.0% | | 4.0% | 26.8% |
| Phosphorus | 13.3% | 36.8% | 4.0% | 8.5% | 12.0% | | | | | 74.5% |
| Magnesium | 13.3% | 36.8% | 3.8% | 7.0% | 24.0% | | | | | 84.9% |
| Iron | 11.6% | 16.0% | | | 7.5% | 6.7% | 10.0% | | 35.0% | 86.8% |
| Zinc | 10.0% | 20.8% | | 5.3% | 9.0% | | | | | 45.1% |
| Molybdenum | 10.0% | | 3.8% | | | | | | | 13.8% |
| Selenium | 10.0% | 39.0% | | | | | | | | 49.0% |
| Fibre | 6.7% | | 2.8% | | 1.2% | | 8.0% | 0.4% | 80.0% | 99.1% |
| Potassium | | | | | | | 7.0% | | | 7.0% |
| Sodium | | | | | | | | | | 0.0% |
| Vitamin B1 | 10.0% | 51.2% | | | 7.5% | | | 30.3% | | 99.0% |
| Vitamin B2 | | 12.0% | 4.5% | | 1.2% | | | 20.0% | | 37.7% |
| Vitamin B3 | | 22.4% | | | | | | 6.7% | | 29.1% |
| Vitamin B5 | | 9.6% | | | | | | | | 9.6% |
| Vitamin B6 | | 40.0% | | | 3.0% | | | 11.0% | | 54.0% |
| Folate | | 22.4% | | | 6.0% | | | 16.3% | | 44.7% |
| Vitamin B12 | | | | | | 62.5% | | 29.3% | | 91.8% |
| Biotin | | | 12.2% | | | | | | | 12.2% |
| Vitamin A | | | | | | 10.0% | | | | 10.0% |
| Vitamin C | | 8.0% | | | | | 6.0% | | | 14.0% |
| Vitamin K | | | | | | | 100.0% | | | 100.0% |
| Choline | | 4.8% | | | | | | | | 4.8% |
| Vitamin E | | 92.8% | 10.0% | | | | | | | 102.3% |
| Protein (g) | 3.7 | 3.3 | 1.2 | 1.6 | 3.0 | | | 0.3 | 8.0 | 26.1 |
| Lipid (g) | 9.0 | 19.2 | 2.8 | 4.3 | 4.5 | | | | 3.0 | 42.8 |
| Carbohydrate (g) | | 8.0 | | | | | | | | 8.0 |
| Omega-3 (g) | | | | | 0.8 | | | | | 0.8 |
| Omega-6 (g) | | | | | 2.7 | | | | | 2.7 |

188.6 g of Formula 3 contains: 15.0 g sesame; 40.0 g sunflower; 5.6 g almonds; 10.0 g cashews; 9.0 g hemp seeds; 0.5 g powdered green algae; 8.0 g wheat grass; 0.5 g yeast; and 100.0 g wheat bran powder. The percentage of daily recommended intake of the various nutrients, vitamins and minerals contributed by the specific ingredients are again expressed in the body of the table. By reference to Table 3 it can be seen that a serving of Formula 3 contains 39.8 g unprocessed oil & fat (lipids), 3.0 g roasted oil & fat (lipids) from roasted wheat bran. The daily value of 42.8 g oil & fat (lipids) will be 64.2% of the recommended daily intake. The daily value of oil & fat (lipids) may be considered to be relatively high in the formulae, however, they only contain unprocessed natural healthy oil & fat (lipids). This level of intake of healthy oil & fat (lipids) will keep the customers from taking in the unhealthy oil & fat (lipids) of the unhealthy food products. The customers will have a healthier diet routine if they consume the products regularly alone with other kinds healthy foods.

It is generally contemplated that the dry ingredients are weighed and combined in accordance with the desired formulation. The combined dry ingredients are then milled, ground or pulverized to the appropriate particulate size. Alternatively, it is possible to mill, or grind individual ingredients to a flour, then weigh each ingredient and mix together in the appropriate weight combination.

Typical particle sizing after having been processed would be expected to be in region of between 30 to 10 US mesh (560 to 2000 microns), preferably 24 to 14 US mesh (690 to 1400 microns) and more preferably 20 to 18 US mesh (850 to 1000 microns).

The particulate formulation is then weighed into the appropriate amounts and packaged into individual snack packages/pouches, one or more moisture or oxygen absorbing sachets may be inserted into the individual snack packages/pouches, excess air is removed from the individual snack packages/pouches, individual snack packages/pouches are sealed. Certain embodiments of the process allow for air to be removed from the individual snack packages/pouches via vacuum, and the sealing of the individual snack packages/pouches can be achieved by heat. The packages may be fabricated from cellophane, plastic or various metalized materials. In a preferred embodiment, dark colored or light impermeable food pouches may be used to keep the light (sun or fluorescent) away from the product.

All the food materials should be very dry to keep the bacterium from growing if they are present in the ingredients when the bags been vacuum sealed. The water activity of all the food materials should meet with certain requirements. Inserting one or more moisture or oxygen absorbing sachets into each single food bag will eliminate the remaining moisture and oxygen which happen to stay in the bag when vacuum seal has been finished, thereby providing the products with a longer shelf life.

More specifically, in one embodiment, the following processing steps are taken: (i) ingredients are selected to meet the ratios of the recipe being prepared; (ii) the ingredients are inspected to ensure that they are in good condition and not damaged, tainted, or spoiled; (iii) the dry ingredients are introduced into a milling machine, a blender or a grinder and processed to the desired particle size; (iv) the processed dry ingredients are then passed through an appropriately sized sieve; (v) the appropriate amount of sieved ingredients is then packed into individual snack packages/pouches; (vi) one or more moisture or oxygen absorbing sachets may optionally be inserted into the individual snack packages/pouches; (vii) excess air is removed from the individual snack packages/pouches; and (viii) the individual snack packages/pouches are sealed.

The products are made from raw materials and most nutrients and natural flavor may be preserved through a low temperature processing technology. The process involves using a low speed stone mill instead of the high-speed metal blade grind machine. The stone mill is cooled, to approximately 8C-15C, or refrigerated, to between 2C-8C, prior to milling the nuts and seeds into the flour. Consequently, the stone mill components will lower the temperature of the food materials upon contact, so the temperature of the food materials will be low during the process.

Various different flavorings, including, but not limited to: salt, pepper (including black pepper), vanilla, caramel, peppermint, citrus or coconut flavoring, cocoa powder, cinnamon, nutmeg, ginger, chili, cumin, coriander, curry, barbecue flavoring, paprika or garlic may be added to the dried ingredients prior to processing. The product will have more flavor and healthy functions if food materials such as goji flour, Chinese date flour, American ginseng flour, Korean ginseng flour, Astragalus membranaceus flour, panax notoginseng (sangti) flour, root of pilose asiabell flour, roasted Chinese yam flour, black beans flour, cauliflower flour, mushroom flour, tomato flour, grape seeds flour, lecithin flour, protein, digestive enzymes, ganoderma flour, and powdered milk are incorporated.

The dried ingredients in certain formulations, such as Formula 1 and Formula 2, can then be mixed with wet ingredients such as oil. Formula 3 is particularly well suited to be mixed with other wet ingredients, such as tea, coffee, cream, milk, juice, yogurt, honey, glucose, corn syrup, soup stocks and broths. The wet ingredients can be used in small quantities as binders that allow for the formulation to be consumed in moist balls and possibly eaten with a spoon. In alternative embodiments, the dry ingredients plus binder can be pressed into pans and formed into squares or bars. The bars may be dried, either at room temperature or in an oven on a low heat setting, to form a crunchy consistency.

Alternative embodiments of the formulations can be sprinkled onto raw foods, including but not limited to fruits, vegetables and salads. Yet further embodiments of the formulations can be sprinkled onto deserts or breakfast foods including but not limited to yogurts and cereals. Additional embodiments of the formulations can be sprinkled onto foods prior to or during the cooking process including but not limited to soups, cake and brownie batters, pasta, rice and noodle dishes, omelets and various egg recipes. The nut and seed flour can either be substituted for some or used to replace all conventional baking flours during the baking of various recipes. Leavening agents, such as baking powder or baking soda, may additionally need to be added in certain circumstances.

The formulations contain a large amount of fiber which keeps the digestive system clean and regular. The formulations are easy to digest because the seeds and nuts have been finely ground, making them an excellent source of nutrition and fiber for the elderly.

The various formulations contain significant quantities of: copper; manganese; calcium; phosphorus; magnesium; iron; zinc, molybdenum; selenium; fiber; potassium; sodium; vitamin B1; vitamin B2; vitamin B3; vitamin B5; vitamin B6; vitamin B12; folate; biotin; vitamin A; vitamin C; vitamin K; choline; protein; lipids; carbohydrates; vitamin E; omega-3 and omega-6.

The product will work well for weight management, fighting fatigue, stimulating hair growth and rejuvenating body cells. It will be good for the bowl movement, the digestive system, etc. The products are easy to consume, especially for middle aged and old people, as they contain fine milled nut and seed particles.

Studies listed on the website: www.whfoods.org show that copper provides relief for rheumatoid arthritis. Copper is known for its use in reducing some of the pain and swelling of rheumatoid arthritis. Copper's effectiveness is due to the fact that this trace mineral is important in a number of anti-inflammatory and antioxidant enzyme systems. In addition, copper plays an important role in the activity of lysyl oxidase, an enzyme needed for the cross-linking of collagen and elastin—the ground substances that provide structure, strength and elasticity in blood vessels, bones and joints. Copper will work together with the components of the black hulls from black sesame seeds to help keep the coloring pigments in hair, resulting in hair remaining dark instead of turning gray with age.

Magnesium supports vascular and respiratory health. Studies have supported magnesium's usefulness in: a) preventing the airway spasm in asthma; b) lowering high blood pressure, a contributing factor in heart attack, stroke, and diabetic heart disease; c) preventing the trigeminal blood vessel spasm that triggers migraine attacks; d) restoring normal sleep patterns in women who are experiencing unpleasant symptoms associated with menopause.

Magnesium is known to relax nerves, muscles and blood vessels. Magnesium counterbalances calcium, thus helping to regulate nerve and muscle tone. In many nerve cells, magnesium serves as Nature's own calcium channel blocker, preventing calcium from rushing into the nerve cell and activating the nerve. By blocking calcium's entry, magnesium keeps our nerves (and the blood vessels and muscles they enervate) relaxed. If our diet provides us with too little magnesium, however, calcium can gain free entry, and the nerve cell can become over-activated, sending too many messages and causing excessive contraction. Insufficient magnesium can thus contribute to high blood pressure, muscle spasms (including spasms of the heart muscle or the spasms of the airways symptomatic of asthma), and migraine headaches, as well as muscle cramps, tension, soreness and fatigue.

Calcium helps prevent colon cancer, osteoporosis, migraine and PMS. In recent studies, calcium has been shown to: a) help protect colon cells from cancer causing chemicals; b) help prevent the bone loss that can occur as a result of menopause or certain conditions such as rheumatoid arthritis; c) help prevent migraine headaches in those who suffer from them; and d) reduce PMS symptoms during the luteal phase (the second half) of the menstrual cycle.

Zinc is especially important for bone health particularly bone mineral density, especially for elderly men. Although osteoporosis is often thought to be a disease for which postmenopausal women are at highest risk, it is also a potential problem for older men. Almost 30% of hip fractures occur in men, and 1 in 8 men over age 50 will have an osteoporotic fracture. A study of 396 men ranging in age from 45-92 that was published in the American Journal of Clinical Nutrition found a clear correlation between low dietary intake of zinc, low blood levels the trace mineral, and osteoporosis at the hip and spine.

Phytosterols from sesame seeds and sunflower seeds may lower cholesterol. Phytosterols are compounds found in plants that have a chemical structure very similar to cholesterol, and when present in the diet in sufficient amounts, are believed to reduce blood levels of cholesterol, enhance the immune response and decrease risk of certain cancers.

Improved detoxification and cancer prevention from has been reported in connection with sunflower seeds selenium. Sunflower seeds are a good source of selenium, a trace mineral that is of fundamental importance to human health. Accumulated evidence from prospective studies, intervention trials and studies on animal models of cancer has suggested a strong inverse correlation between selenium intake and cancer incidence. Selenium has been shown to induce DNA repair and synthesis in damaged cells, to inhibit the proliferation of cancer cells, and to induce their apoptosis, the self-destruct sequences the body uses to eliminate worn out or abnormal cells.

In addition, selenium is incorporated at the active site of many proteins, including glutathione peroxidase, which is particularly important for cancer protection. One of the body's most powerful antioxidant enzymes, glutathione peroxidase is used in the liver to detoxify a wide range of potentially harmful molecules. When levels of glutathione peroxidase are too low, these toxic molecules are not detoxified. It is believed that such toxins damage their cellular DNA and may increase the development of cancer cells.

Anti-inflammatory and cardiovascular benefits from sunflower seeds may be related to their high levels of vitamin E. Sunflower seeds are an excellent source of vitamin E, the body's primary fat-soluble antioxidant. Vitamin E travels throughout the body neutralizing free radicals that would otherwise damage fat-containing structures and molecules, such as cell membranes, brain cells, and cholesterol. By protecting these cellular and molecular components, vitamin E has significant anti-inflammatory effects that result in the reduction of symptoms in asthma, osteoarthritis, and rheumatoid arthritis, conditions where free radicals and inflammation play a big role. Vitamin E has also been shown to reduce the risk of colon cancer, help decrease the severity and frequency of hot flashes in women going through menopause, and help reduce the development of diabetic complications.

In addition, vitamin E plays an important role in the prevention of cardiovascular disease. Vitamin E is one of the main antioxidants found in cholesterol particles and helps prevent free radicals from oxidizing cholesterol. Only after it has been oxidized is cholesterol able to adhere to blood vessel walls and initiate the process of atherosclerosis, which can lead to blocked arteries, heart attack, or stroke. Getting plenty of vitamin E can significantly reduce the risk of developing atherosclerosis. In fact, studies show that people who consume adequate amounts of vitamin E are at a much lower risk of dying of a heart attack than people whose dietary intake of vitamin E is marginal or inadequate.

It is apparent from the foregoing that a new and improved highly nutritious snack food, supplement product or flour and process of manufacture of same have been provided.

The foregoing descriptions of specific embodiments of the present invention have been presented for purposes of illustration and description. They are not intended to be exhaustive or to limit the invention and method of use to the precise forms disclosed. A worker skilled in the art will realize that many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present invention.

What is claimed is:

1. A food product, comprising in admixture ingredients selected from:
black sesame seeds; white sesame seeds; sunflower seeds; almonds; cashews hemp seeds; green algae; wheat grass; yeast; green tea; ginger; sugar; wheat bran powder; walnuts; brazil nuts; pecan nuts; peanuts; chia; poppy seeds; flex seeds; and pumpkin seeds.

2. The food product of claim 1, wherein the selected ingredients are milled, pulverized or ground into particles.

3. The food product of claim 2, wherein the particle size is in the region of between 30 to 10 US mesh (560 to 2000 microns).

4. The food product of claim 2, wherein the particle size is in the region of between 24 to 14 US mesh (690 to 1400 microns).

5. The food product of claim 2, wherein the particle size is in the region of between 20 to 18 US mesh (850 to 1000 microns).

6. A snack food or supplement comprising the food product of claim 2, packaged into individual snack packages or pouches and optionally one or more moisture or oxygen absorbing sachets.

7. The snack food or supplement of claim 6 wherein the individual snack packages or pouches are vacuum sealed.

8. The food product of claim 2, wherein one or more flavorings or powdered components are added to the selected ingredients,
said flavorings being selected from: salt; pepper (including black pepper); vanilla; caramel; peppermint; citrus or coconut flavoring; cocoa powder; cinnamon; nutmeg; ginger; chili; cumin; coriander; curry; barbecue flavoring; paprika; and garlic, and
said powdered components being selected from: Chinese date flour; American ginseng flour; Korean ginseng flour; Astragalus membranaceus flour; panax notoginseng (sangti) flour; root of pilose asiabell flour; roasted chinese yam flour; black beans flour; cauliflower flour; mushroom flour; tomato flour; grape seeds flour; lecithin flour; protein; digestive enzymes; ganoderma flour; and powdered milk.

9. Use of the food product of claim 8 to prepare a dietary supplement, wherein the ingredients and one or more flavorings or powdered components are mixed with oils; teas; coffee; cream; milk; ganache; fruit juice; yogurt; honey; glucose; corn syrup; soups; stocks; and broths.

10. Use of the food product of claim 8 to increase the fiber and nutritional value of raw foods, by sprinkling onto fruits; vegetables; salads; desserts; breakfast foods; yogurts; and cereals.

11. Use of the food product of claim 8 to increase the fiber and nutritional value of foods prior to or during the cooking process, including soups; cakes; pastries; batters; pasta; rice; noodle dishes; omelets; and various egg recipes.

12. Use of the dietary supplement of claim 9 to prepare baked products including bars or squares.

13. A method of preparing a snack food or supplement, comprising the steps of:
choosing desired dry ingredients selected from: black sesame seeds; white sesame seeds; sunflower seeds; almonds; cashews hemp seeds; green algae; wheat grass; yeast; green tea; ginger; sugar; wheat bran powder; walnuts; brazil nuts; pecan nuts; peanuts; chia; poppy seeds; flex seeds; and pumpkin seeds;
combining the dry ingredients;
milling, grounding, or pulverizing the dry ingredients to the appropriate particulate size;
packaging the milled, ground or pulverized dry ingredients individual snack packages or pouches;
optionally inserting one or more moisture or oxygen absorbing sachets into the individual snack packages or pouches;
removing excess air from the individual snack packages or pouches;
sealing the individual snack packages or pouches.

14. The method of preparing a snack food or supplement according to claim 13, wherein the removing of excess air from the individual snack packages or pouches by vacuum.

15. The method of preparing a snack food or supplement according to claim 13, wherein the sealing of the individual snack packages or pouches is achieved by heat.

16. The method of preparing a snack food or supplement according to claim 13, wherein the milling, grounding, or pulverizing the dry ingredients to the appropriate particulate size it conducted at a temperature of between 2C-15C.

17. The method of preparing a snack food or supplement according to claim 13, wherein the appropriate particulate size is between 30 to 10 US mesh (560 to 2000 microns).

18. The method of preparing a snack food or supplement according to claim 13, wherein the appropriate particulate size is between 24 to 14 US mesh (690 to 1400 microns).

19. The method of preparing a snack food or supplement according to claim 13, wherein the appropriate particulate size is between 20 to 18 US mesh (850 to 1000 microns).

20. The method of preparing a snack food or supplement according to claim 13, comprising the additional step of adding one or more flavorings or powdered components to the dry ingredients prior to packaging,
said flavorings being selected from: salt; pepper (including black pepper); vanilla; caramel; peppermint; citrus or coconut flavoring; cocoa powder; cinnamon; nutmeg; ginger; chili; cumin; coriander; curry; barbecue flavoring; paprika; and garlic, and
said powdered components being selected from: Chinese date flour; American ginseng flour; Korean ginseng flour; Astragalus membranaceus flour; panax notoginseng (sangti) flour; root of pilose asiabell flour; roasted chinese yam flour; black beans flour; cauliflower flour; mushroom flour; tomato flour; grape seeds flour; lecithin flour; protein; digestive enzymes; ganoderma flour; and powdered milk.
